(19) United States
(12) Patent Application Publication
(10) Pub. No.: US 2007/0199804 A1
(43) Pub. Date: Aug. 30, 2007

(54) Two part cleanable keyboard

(75) Inventors: Peter D. Joseph, Twin Lakes, WI (US); Richard W. Fitzgerald, Franklin, WI (US)

Correspondence Address: BRINKS HOFER GILSON & LIONE, P.O. BOX 10395, CHICAGO, IL, 60610, US

(73) Assignee: Cherry Corporation

(21) Appl. No.: 11/363,135

(22) Filed: Feb. 27, 2006

(51) Int. Cl. H01H 13/72

(52) U.S. Cl. 200/5 A

(57) ABSTRACT

A two-part cleanable keyboard includes an upper keyboard portion with a plurality of keys. A lower support portion includes an impermeable moisture barrier. The two portions easily snap-fit together to make a quick assembly for computer use. The portions also detach easily so the upper portion may be cleaned or sterilized after a first user, while a spare or additional upper portion is snap-fit onto the lower portion for use by a second user. The keyboard provides tactile feedback to the user in the form of a full-travel feel when each key is pressed and released. The lower portion may be cleaned or disinfected when the upper portion is changed. By restricting use of the keyboard itself to a single user or to a minimal number of users, the risks of passing on organisms that cause infections in a hospital or other care institution is kept to a minimum.

### FIELD OF THE INVENTION

The technical field of the invention is keyboards and data-entry devices.

### BACKGROUND OF THE INVENTION

Hospitals and other medical care providing institutions are becoming more automated and more efficient in their operations. One way in which these changes manifest themselves is in the handling and recording of data, especially day-to-day and moment-to-moment patient care data. In the past, residents and nurses would note changes or instructions on a chart for the patient. Personnel coming on duty for the next shift would note the changes and be prepared for the appropriate next steps of care.

Of course, manual recording of data has disadvantages, including handwriting that is difficult to read. In addition, if the change of shift takes place so rapidly that instructions or warnings cannot be given verbally to the next caregiver, it is possible that the instructions or warning may not be passed on. Alternatively, a caregiver might have to make the rounds of each patient, seeing whether each patient has special needs or whether special caution might be warranted on that shift.

It is no surprise then, that such patient care data is now often recorded electronically. A nurse or a doctor can make notes with a computer, entering data, such as status data, and also entering instructions or cautions. In many cases, the station for each patient may have a computer and data entry means, as shown in U.S. Pat. No. 6,339,410. The data entry means may include a keyboard as shown. In some areas of an institution, such as the intensive care unit, there may be multiple means of entering data, such as a touch screen as well as a keyboard. Thus, many users may easily and quickly enter data into the computer and the record of care of the patient is updated by each caregiver.

There is at least one drawback, however, to the use of the computer and the keyboard by so many persons. Germs and other causes of infection, such as bacteria and viruses, may be placed on the surface of the computer and especially on the keyboard by a user. A subsequent user, such as a caregiver, many accidentally become contaminated with the organism when entering data with the keyboard. The organism may then be passed to one or more patients, causing an infection, to the detriment of those patients.

In addition to these uses, the patient may also use such a keyboard. In some hospitals, patients during their recuperation periods have access to a computer and a keyboard. Patients may compose and answer e-mails, do a variety of work, perform Internet or intranet searches, or play computer games using a bedside computer and keyboard.

One solution to the problem of passing infection between users is to limit the use of the keyboard to a single user, but this solution would be expensive. Of course, the keyboard may be cleaned between uses or between users, but this solution poses an additional problem in the time involved in cleaning the keyboard. In addition, the keyboard must be water-proof. Solutions have been proposed along these lines, but are unsatisfactory for one reason or another. For example, U.S. Pat. No. 6,542,355 discloses a water-proof keyboard, but the keyboard appears to have many crevices and reservoirs that could retain moisture after cleaning and would be undesirable in keeping the keyboard clean between users. U.S. Pat. No. 6,534,210 and U.S. Pat. Appl. Publ. 2003/0222800 have similar drawbacks and would also have to be cleaned between users to maintain a clean environment on the keyboard.

What is needed is a way to easily and quickly clean or decontaminate a keyboard between users so that patients are subjected to the least possible risk of infection during their stay in a hospital or other care institution.

### BRIEF SUMMARY

One aspect of the invention is a two-part cleanable keyboard with an upper portion and a lower portion. The upper portion has a frame with at least two quick connections and a plurality of keycaps. The lower portion with mating quick connections has a housing and a moisture-resistant barrier, a plurality of electrical circuits adapted to convert keystrokes into electrical signals, a control circuit connected to the electrical circuits, and an output circuit connected to the control circuit. There is also a reactive mat that includes a plurality of domes in registration with the plurality of keycaps, the reactive mat assembled to an underside of the upper portion or to an upper side of the lower portion.

Another aspect of the invention is a cleanable, two-part keyboard. The keyboard includes a removable keypad frame with a plurality of keycaps and a sealed base. The sealed base has a housing, a plurality of electrical circuits within the housing, a control circuit connected to the plurality of electrical circuits, and a moisture-resistant barrier adhered to the housing. There is also a reactive mat assembled to an underside of the removable keypad or to an upper side of the base portion.

Another aspect of the invention is a two-part cleanable keyboard. The two-part keyboard includes a removable, cleanable keypad frame with a plurality of keycaps, and a sealed base. The base includes a housing, a reactive layer with a plurality of features in registration with the plurality of keycaps, a plurality of electric circuits in registration with the reactive layer, a control circuit connected to the plurality of electrical circuits, and a sealing layer, wherein the frame and the base further include quick connectors, and the keycaps and reactive layer are configured for a user to receive a full-travel tactile feedback during use.

There are many aspects of the invention, of which the drawings and descriptions below illustrate only a few of the preferred embodiments, and which are meant to be illustrative, rather than limiting.

### BRIEF DESCRIPTION OF THE DRAWINGS

FIG. 1 is a first embodiment of a two-part keyboard;

FIG. 2 is a cross-sectional view of the embodiment of FIG. 1;

FIG. 3 is a partial exploded view of the embodiment of FIG. 1;

FIG. 4 is a partial exploded view of the bottom portion of FIG. 1;

FIG. 5 is an exploded view of lower portion of a keyboard;

FIGS. 6-8 are embodiments of quick-release attachments useful in two-part keyboard embodiments;

FIG. 9 is a partial view of a keyboard frame useful in embodiments of the two-part keyboard;

FIG. 10 is a schematic view of a circuit for controlling and transmitting signals from the two-part keyboard;

FIG. 11 is a second embodiment of a two-part keyboard;

FIG. 12 is a partial cross-sectional view of the embodiment of FIG. 11;

FIGS. 13a-13d are partial cross-sectional views of additional embodiments; and

FIG. 14 is an isometric view of an additional embodiment.

### DETAILED DESCRIPTION OF THE DRAWINGS AND THE PRESENTLY PREFERRED EMBODIMENTS

The two-part keyboard includes an upper portion, a user interface that includes the keys associated with a keyboard. The lower portion includes virtually all the remaining parts, including the electronics that tell the computer to associate a particular character with a keystroke by the user. It is clear that the upper portion needs to be cleanable and sterilizable, and the lower portion needs to be both cleanable and moisture resistant, so that it may be at least wiped clean when the upper portion is replaced by an upper portion of a new user.

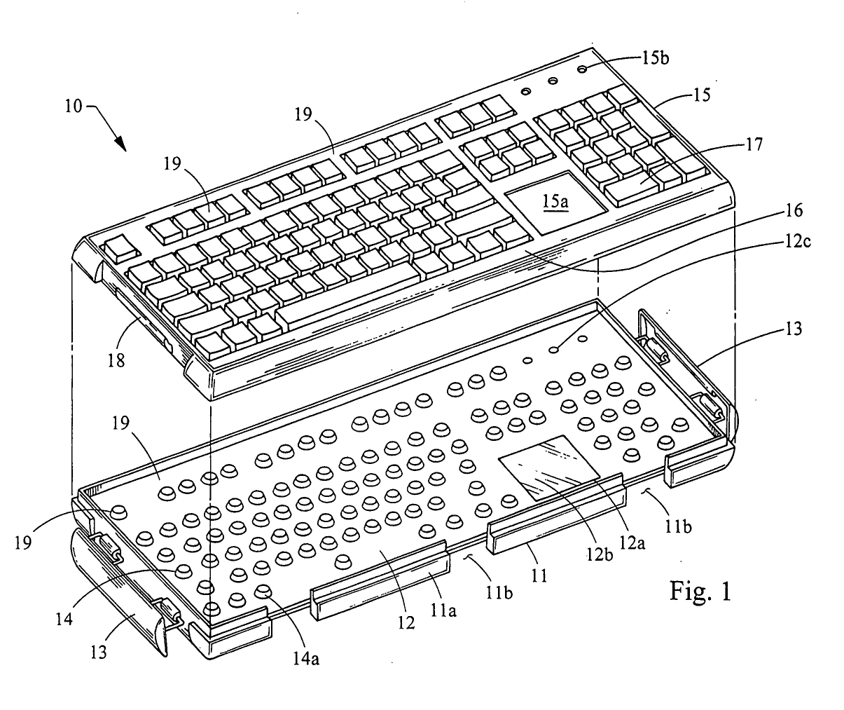

FIGS. 1-4 disclose a first embodiment of a two-part keyboard. In FIG. 1, the two-part keyboard 10 is seen to include a lower portion 11 and an upper portion 15. Lower portion 11 includes a lower frame 11a, an impermeable seal layer 12 and quick-connect connectors or latches 13, preferably on both the left and right hand sides of lower portion 11, and also preferably on the front and rear sides (not shown). Lower portion 11 also includes a tactile mat 14 with a plurality of protrusions 14a that extend through seal layer 12. The outer frame of lower portion 11 may include scuppers or drain paths 11b so that condensation or moisture is able to drain away from the keyboard.

Seal layer 12 may also have an adhesive-free zone 12a so that a touchpad pointing device 12b is accessible to a user. The touchpad pointing device 12b extends through seal layer 12 and is connected to the control circuitry of the keyboard. Seal layer 12 also is preferably transparent so that light from LEDs within lower portion 11 may be seen by a user. If seal layer 12 is not reasonably transparent, windows 12c may be sealed to seal layer 12 so that light from within lower portion 11 will be visible to a user. Some embodiments may not have a touch pad, for instance if a mouse is used, but touchpad models are preferred.

Seal layer 12 is tightly and impermeably bonded to tactile mat 14 with a layer of adhesive 26. The layer may be a laminate of pressure-sensitive adhesive, with holes cut out for protrusions 14a. Alternately, the adhesive may be applied by another method, such as dipping or spraying. The adhesive is preferably distributed in a uniform layer over the entire under-surface of seal layer 12. The bottom portion may also include one or more coatings 19 over the protrusions and seal layer 12. Upper portion 15 may also be coated with one or more coatings 19, described below.

Upper portion 15 includes frame 16 and latch portions 18, also preferably on both the left and right hand sides of upper portion 15, and also preferably on the front and rear of the keyboard (not shown). Frame 16 has penetration 15a to allow a user to touch touch-pad pointing device 12a in the lower portion of the keyboard, when the keyboard is assembled for use. Additional penetrations 15b may be used to allow a user to see light from LEDs within lower portion 11. An example is a “caps lock” LED that allows a user to determine that the “caps lock” key has been depressed. Clear plastic inserts may be used instead of penetrations.

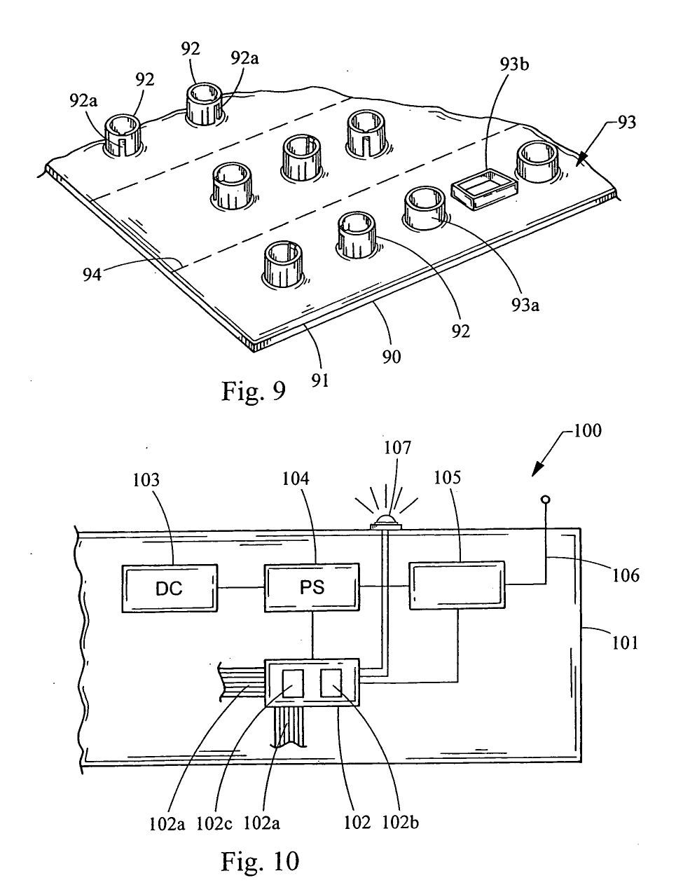

Keys or keycaps 17 fit into frame 16 for manipulation by a user. The principal portion of the frame is a flat piece of plastic (see FIGS. 3 and 9), preferably with ribs protruding from the underside for stability, and preferably with raised circular holes or orifices for the keys that will be placed into the frame. Frame 16 or keycaps 17, or both, may have a coating 19.

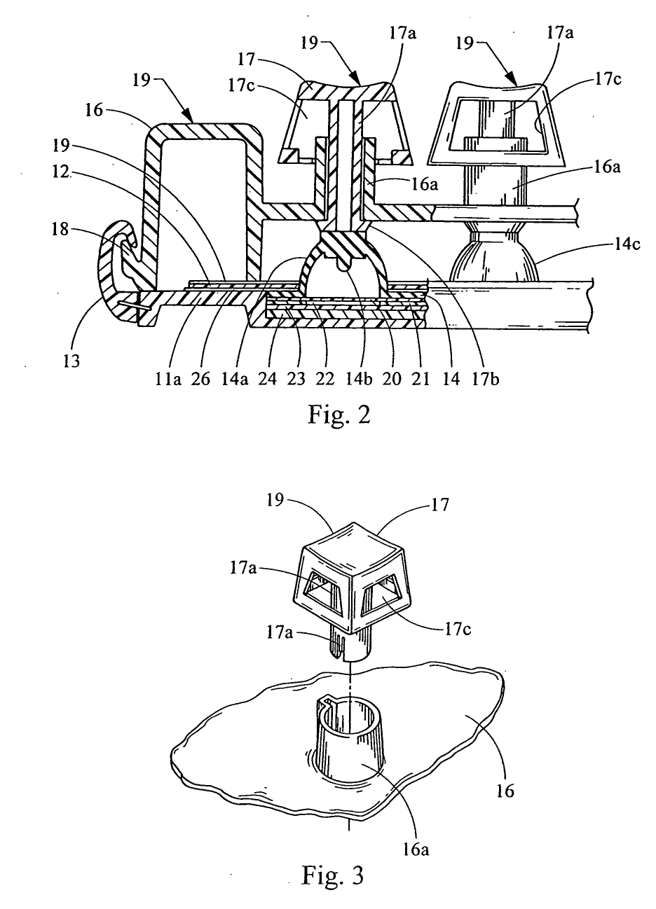

FIG. 2 depicts a partial cross-sectional view of the two-part keyboard embodiment of FIG. 1. Upper frame 16 is clamped to lower frame 11a using lower latch 13 and upper latch 18. Keycap shafts 17a from keycaps 17 extend through bosses 16a on frame 16 and are movably captured on the underside of the frame by snap-fits 17b. The keycaps may have cutouts or windows 17c in their sides to reduce the surface area on which contaminants may be captured. Such cutouts may also allow better access for cleaning solutions to flow through, clean the upper portion, and dry.

The lower portion 17b of keycap stem 17a interfaces with the tactile mat 14 to allow the user to communicate with a computer (not shown) or other device controllable by the two-part keyboard. Tactile mat 14 includes upwardly extending protrusions 14a. In this partial cross-section, protrusion 14a is shown in cross section, with internal descending portion 14b. Protrusion 14c depicts the dome-shaped outside (but not the cross-section) of an identical protrusion. When a user depresses a keycap 17, stem 17a depresses a protrusion lower portion 14b into the space above the flat portion of the tactile mat 14, and also depresses one or more of the layers below the tactile mat.

The seal membrane 12 and tactile mat 14 are secured to the lower frame 11a with an adhesive layer 26. Below the tactile mat and adhesive are the working layers of the lower portion. The upper working layer may be an upper circuit film 20, with circuits corresponding to each key printed or deposited on its lower side. There may be an insulating layer 21 with cutouts or air gaps 22 corresponding to the protrusions 14a, 14c of the tactile mat 14. A lower circuit film 23 may have circuits also corresponding to each key printed or deposited on its upper side. There may be a stiffener 24 to add stiffness and mass to the lower portion.

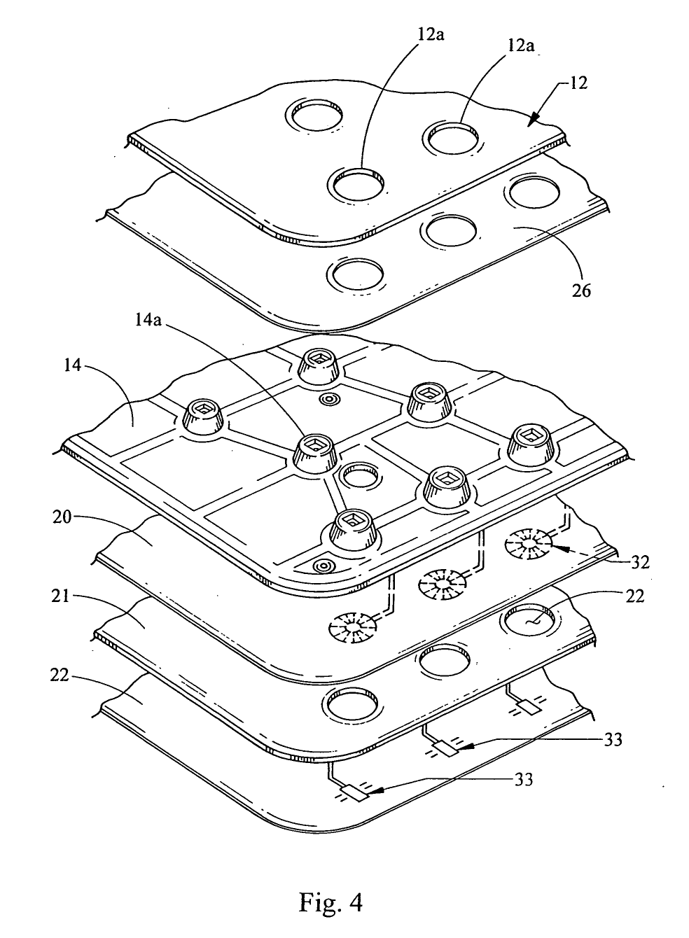

FIGS. 3 and 4 depict a partial exploded view of the embodiment of FIG. 1. In FIG. 3, each keycap 17 fits into keyboard frame 16 through a raised boss or interface 16a on the frame and the keycap stem 17a. Keycap stem 17a is preferably longer than the height of boss 16a and is retained in the boss via male snap fit feature 17b. The difference in heights should be about ⅛″ to about ¼″, so that the user is able to experience a “full-travel” feeling when the user depresses a key. Keycap 17 may have windows or cutouts 17c. FIG. 4 depicts a partial exploded view of the lower portion 11. Seal layer 12, the top layer of the lower portion, has cutouts 12a to allow the domes 14a of tactile mat 14 to protrude through seal layer 12. Adhesive layer 26 underlies seal layer 12 and impermeably seals tactile mat 14 to the seal layer. The adhesive also seals the tactile mat edges to lower portion frame 11a.

Within lower portion 11, an upper circuit film 20 with printed circuits or traces 32 on its underside is in registration with domes 14a of the tactile mat. Insulating layer 21 with cutouts or air gaps 22 is also in registration with the circuits or traces of upper film 20 and with traces or circuits 33 on lower circuit film 23. When a user depresses keycap 17, stem 17a depresses the particular tactile mat dome 14a that corresponds to that key. The dome that is depressed pushes the circuit on upper film 20 into contact with the circuit on lower film 23. This closes a circuit between the upper and lower traces and signal processing circuitry within the lower portion allows the user to communicate using the keyboard.

The resilience, the slight resistance or reactance, of the silicone dome during key depression, and the push-back of the dome when the key is released gives the keyboard user the tactile feedback or full-travel feel needed to assure the user that the keyboard is operating properly. Silicone elastomer has the correct “feel” and flexibility that is useful for this purpose and is preferred as a keypad interface. Other elastomers may be used instead, for instance thermoplastic elastomers (TPEs), such as Santoprene from Monsanto, or nitrile elastomers, to form this support layer for the keys. In other embodiments, the underside of the dome may include a small piece of metal or a magnet, for activating a circuit within the bottom portion.

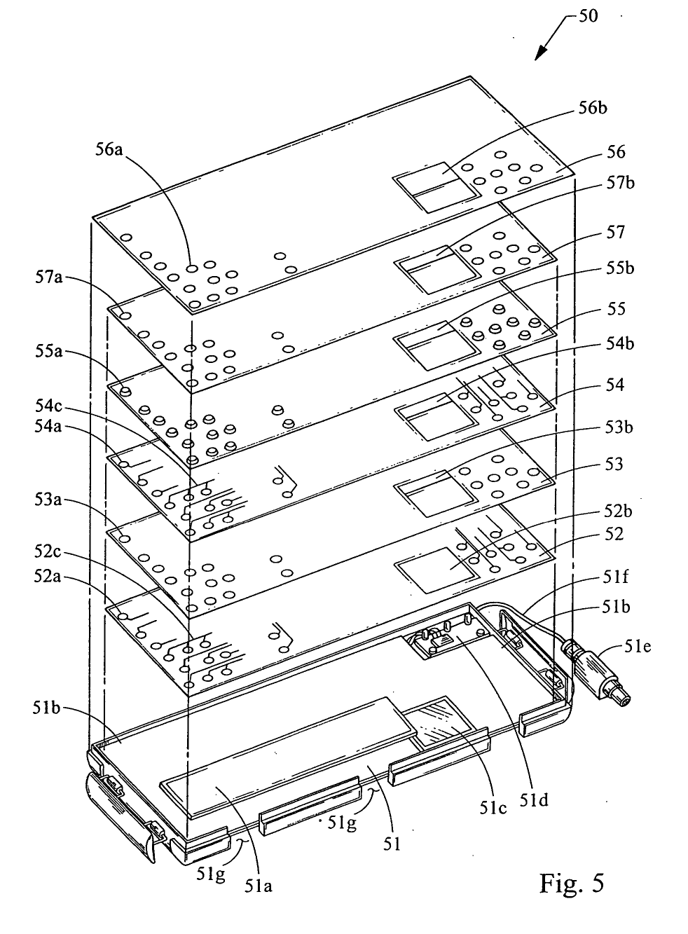

FIG. 5 depicts an exploded view of an embodiment of the second or lower portion 50 of the keyboard. This embodiment may be the same as the lower portion embodiment of FIGS. 1-4 or it may be different. Lower portion 50 includes a housing or frame 51, a lower circuit layer 52, an insulating layer 53, an upper circuit layer 54, tactile mat 55 and seal layer 56. Adhesive layer 57, which may be in a sheet form, lies between tactile mat 55 and seal layer 56. Adhesive layer 57 also seals the seal layer to sealing surfaces or lips 51b on the inner periphery of frame 51. Circuit layers 52, 54 are preferably separate layers of flex-circuitry printed on a thin, flexible plastic film.

Frame 51 may include a stiffener 51a to add weight and stiffness to the lower portion 50. The stiffener may be steel or aluminum, or other suitable material, and is preferably from about 0.050 inches to about 0.100 inches thick. Frame 51 also includes touchpad pointing device 51c. Touchpad pointing device 51c is in contact with control portion 51d housed in frame 51, which also includes connector 51e and cord 51f for interfacing with a computer or other device. Frame 51 may include drain paths 51g and is preferably molded from a polyamide such as nylon, polyvinyl chloride (PVC), polypropylene, polyester, or ABS (acrylonitrile-butadiene-styrene), or other relatively stiff, stable plastic. The material selected should be resistant to water, cleaning solvents, and detergents.

Lower circuit layer 52 is assembled in direct contact with control portion 51d. Each circuit or pad 52a on circuit layer 52 is connected via traces 52c to control portion 51d. The circuits are printed on the upper side of this layer so that they may come in contact with circuits 54a printed on the lower side of upper circuit layer 54, which may be connected by traces 54c. Each circuit or pad 52a of lower layer 52 is in registration with a matching pad 54a of upper circuit layer 54 and also with a cutout 53a in insulating layer 53. Layers 52, 53, 54, may also include windows 52b, 53b, 54b that align with touchpad pointing device 51c.

Circuit layers 52, 54 are preferably made from a thermoplastic film, such as PET (polyethylene terephthalate). Other materials may also be used, such as PEI (polyetherimide) or polyimide. The traces and circuitry are preferably a screen-printed silver epoxy ink, or other conductor applied by a suitable method.

Tactile mat 55 includes a plurality of domes 55a, each dome also in registration with a circuit on lower layer 52 and intermediate layers as already discussed. Tactile mat 55 may also include a window 55b in registration with the touchpad pointing device 51c. Seal layer 56 includes windows 56a for domes 55a and also may include a clear window 56b; alternatively, the entire seal layer 56 may be transparent. Adhesive layer 57 includes windows 57a for the tactile domes and also a window 57b in the area of the touchpad pointing device. Window 57b may alternately be merely an adhesive-free zone in the adhesive film.

Seal layer 56 is important because it must seal the inner components of the keyboard. The seal layer will be subjected to many mechanical stress cycles as the top portion of the keyboard is repeatedly assembled and disassembled with the snap fit or other quick-connect features used for the two portions of the keyboard. The seal layer will also be subjected to repeated cleaning cycles, because every time the upper portion of the keyboard is replaced, a user may perform a quick cleaning or wiping operation on at least the top cover of the lower keyboard portion. The seal layer should therefore be made from a strong, durable, chemically-resistant plastic or elastomer. The seal layer is preferably a thin polyethylene terephthalate (PET) film. Other films and materials may be used.

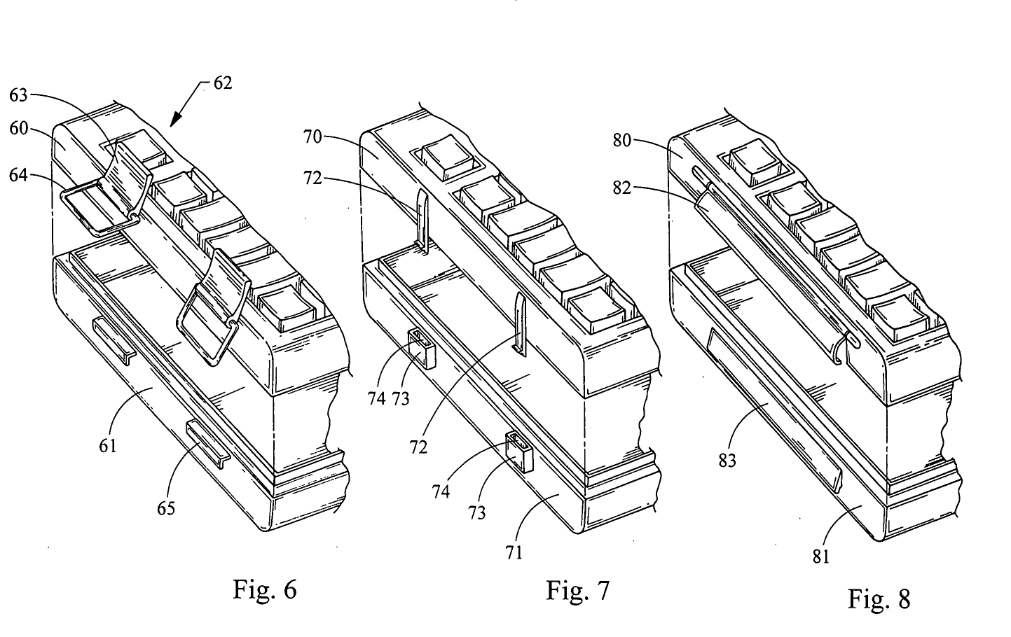

FIGS. 6-8 depict three sets of quick connect hardware. FIG. 6 depicts latches used on top and bottom portions of a cleanable two-part keyboard. In this embodiment, two latches 62 are used on the left-hand side of top keyboard portion 60. Latch 62 includes loop 64 and lever 63 for manipulation by a user. Mating keepers 65 are affixed to bottom keyboard portion 61. The user latches loop 64 into keeper 65 and draws the loop tight with lever 63, thus mating the top and bottom keyboard portions. While the left-side of the keyboard portions are shown, two additional connect and disconnect hardware pieces should also be used on the right side of the keyboard portions. Alternatively, a single piece may be used on each side. In other embodiments, one or two such connects/disconnects may also be used on the front and rear portions of the keyboard portions. In yet other embodiments, the keepers may be attached to the top keyboard surfaces, while the loop and lever portions of the latches on attached to the bottom portions.

FIG. 7 depicts an alternate embodiment in which snap fit connectors are used, again on the left side of the upper and lower keyboard portions. Upper keyboard portion 70 includes two male snap-fit connectors 72 for mating with two matching female snap fit connectors 73 on lower keyboard portion 71. The male connectors are radiused to reversibly snap into orifices 74 in female snap fit connectors 73. The user quickly disconnects the upper and lower keyboard portions by squeezing on the somewhat flexible male connectors 72 and lifting the upper keyboard portion 70. Two additional snap fit connections may also be used on the right side of the keyboard portions. In other embodiments, the snap fit connectors may be used on the front and rear sides in addition to those on the left and right hand sides.

FIG. 8 depicts a third quick-connect and disconnect embodiment. Upper keyboard portion 80 includes a flexible, one-piece cam-action latch 82 to mate with and close on lower boss 83. The user flexes latch 82 to cover boss 83, and then pushes the latch closed, allowing the tip of the latch to be received in a space provided under boss 83.

As will be recognized by those having skill in the mechanical arts, there are many ways to quickly connect and disconnect the upper and lower portions of the keyboard. Ideally, making and breaking the connections many times will have no effect on the reliability of the keyboard. For that reason, if connectors are used, they should be designed for many thousands of connects and disconnects. Especially in hospital or other institutional situations, there may be several changes each day as one care giver after another plugs his or her upper keyboard into the lower keyboard portion which remains with the patient station. At the same time, it is important that the connection be “on register,” i.e., that the upper keyboard be in registration with the pads and electrical circuitry of the lower portion. Thus, the connectors should be very reliable and mechanically stable.

FIG. 9 depicts a top portion 90 of a cleanable keyboard embodiment. Cleanable top 90 includes frame 91 with ribs 94 on the underside and key positions 92 atop the keyboard. Frame 91 is preferably about 2 mm thick (about 0.080 inches) and ribs 94 preferably extend about ⅛ inch to ¼ inch (about 3-6 mm) from the underside of frame 91. Key positions 92 may be in the form of thin hollow cylinders about 5 mm tall (about 0.20 inches). Key positions 92 may each have a notch or cutout feature 92a that makes each position unique, so that only one key, with a corresponding rib or tab will fit into the particular position.

While most keys use a simple position 92, larger keys, such as “backspace” or the zero key on a number pad may have more elaborate positions. Position 93 for a zero key on a number pad includes a two cylindrical protrusions 93a flanking a central rectangular protrusion 93b. The key that fits into this position may also be more elaborate, with matching cylindrical and rectangular protrusions that fit into those provided in position 93. This more elaborate position allows for the emphasis the manufacturer places on the key, while allowing smooth functioning of the key. That is, the larger key will have proper alignment for depression by a user and subsequent re-emergence when the keystroke is complete. This helps to maintain the “tactile feedback” that is important to keyboard users.

FIG. 10 depicts controls 100 for the keyboard. The circuitry may be mounted on a circuit board or flex circuit 101. Control circuitry 102 may include connections 102a to traces on lower circuit layers as described above. Signals from the traces may be handled by a signal processor or amplifier 102c, such as a digital signal processor, or other circuitry. A microprocessor controller 102b may also be used to control the keyboard. Controls for the keyboard may include a battery 103, a power supply 104, and a simple, low-wattage RF transmitter 105 and antenna 106 for wirelessly transmitting electrical signals corresponding to keystrokes to a computer or other device. The keyboard may instead include an infrared LED output 107, which is especially useful for wireless transmission from the keyboard to a nearby computer or other device.

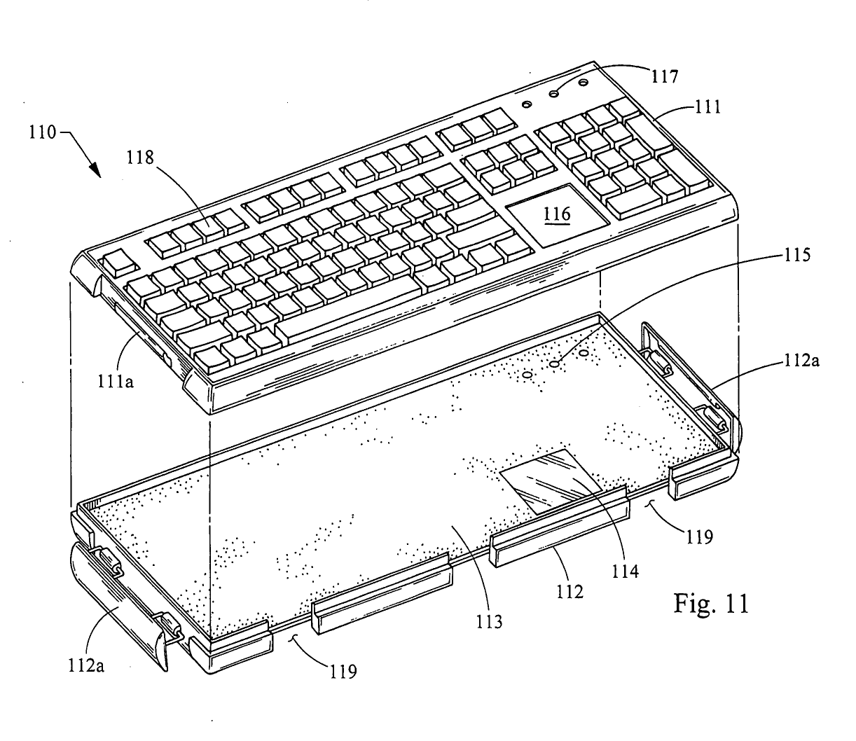

FIG. 11 depicts an alternative embodiment of a two-part keyboard in which the seal layer is continuous across the face of the lower portion. Two-part keyboard 110 includes an upper frame 111 with windows 116, 117, a plurality of keycaps 118, and latch portions 111a. The two-part keyboard also includes lower frame 112, seal layer 113 with clear windows 114, 115 matching latch portions 112a, and drain paths 119. Windows 114, 116 correspond to a touchpad pointing device (not shown) while windows 115, 117 correspond to indicator LEDs within the lower portion of the keyboard.

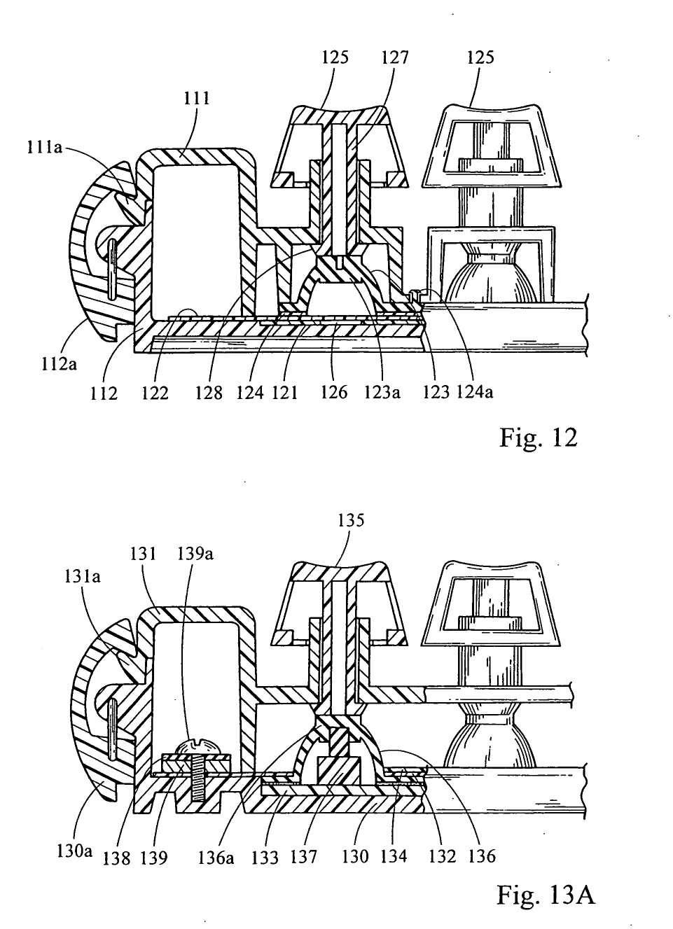

A cross-sectional view of the keyboard of FIG. 11 is depicted in FIG. 12. In this embodiment, there may be no physical contact between the tactile mat and the switching device. The switching technology employed may be inductive, capacitive, or hall-effect based. In this embodiment, a tactile mat 123 is affixed to upper frame 111 by a backing plate 124 by using, for example, snap fit connections 124a. For each keycap 125 of the keyboard, there is a dome 123 on the tactile mat with an activating member 123a. When a user presses on keycap 125, the activating member 123a on stem 127 is brought into close proximity to the lower portion of the keyboard. The lower portion of the keyboard includes lower frame 112, seal layer 122, circuit film layer 121, and responsive circuitry 126 on the circuit film layer.

Circuit film layer 121 includes circuitry 126 corresponding to each keycap for activation by activating members 123a. If the activating member 123a is a small iron or steel cylinder, the responsive circuitry may be a small induction coil that sends a signal to the control circuitry. Alternatively, the responsive circuitry may include a capacitive circuit that sends a signal when a small piece of metal (or other mass with sufficient capacitance) on the tactile mat dome nears the capacitive circuit. If the activating member is a small magnet, the responsive circuitry should be a hall-effect circuit to detect the approach of the magnet.

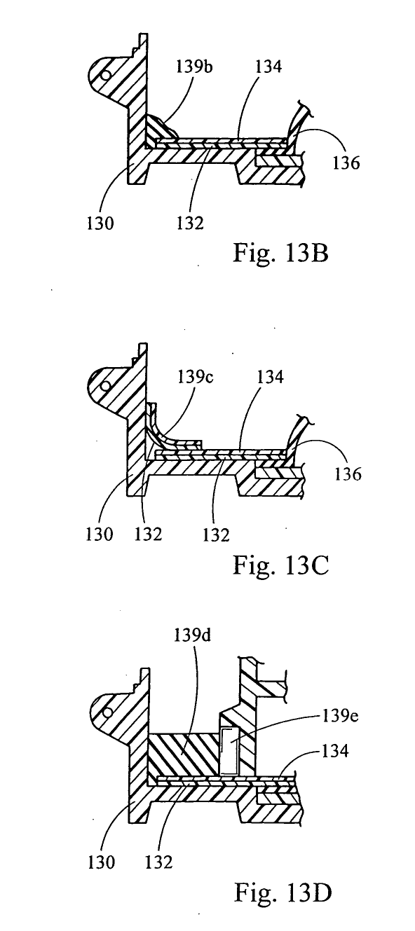

Another embodiment uses a tactile mat and a mechanical switch for each keycap. The embodiment of FIG. 13a has an outward appearance similar to that of FIG. 1, with an upper keyboard made from an upper frame 131 and a plurality of keycaps 135, and a lower portion with a plurality of domes 136a protruding from a tactile mat 136, a seal layer 134, and an adhesive layer 132. In this embodiment, upper frame 131 also has a latch portion 131a, preferably on the left and right hand sides of the frame. The lower portion includes lower frame 130, a stiffening plate 133, tactile mat 136, and seal layer 134. Seal layer 134 seals to both the tactile mat 136 and to the edges or lips of frame 130. Latches 130a, 131a are used to quickly connect and disconnect the upper and lower frames.

When the user depresses a keycap, such a keycap 135, switch 137 is actuated. Switch 137 may be any suitable small switch, such as a microswitch or a profile switch as shown. One switch that is known to work well for the purpose is an MX series desktop profile switch available from Cherry Electrical Products, Pleasant Prairie, Wis. Each switch is connected to signal processing circuitry in the sealed lower portion of the keyboard.

In this embodiment, there is also an auxiliary seal around the lips of the frame, the auxiliary seal including a seal portion 139, a stiffening plate 138, and a fastener 139a to secure the auxiliary seal to lower frame 130. Alternately, as shown in FIGS. 13b-13d, the back-up seal may be made from another layer of adhesive-backed film or tape 132, 139c, or a bead of an adhesive 139b. The bead may be an epoxy adhesive or sealant, a low-pressure polyamide encapsulant, a hot-melt glue, or a Henkel Macromelt® compound 139d. An additional wall or potting box 139e may be used to contain the epoxy or encapsulant.

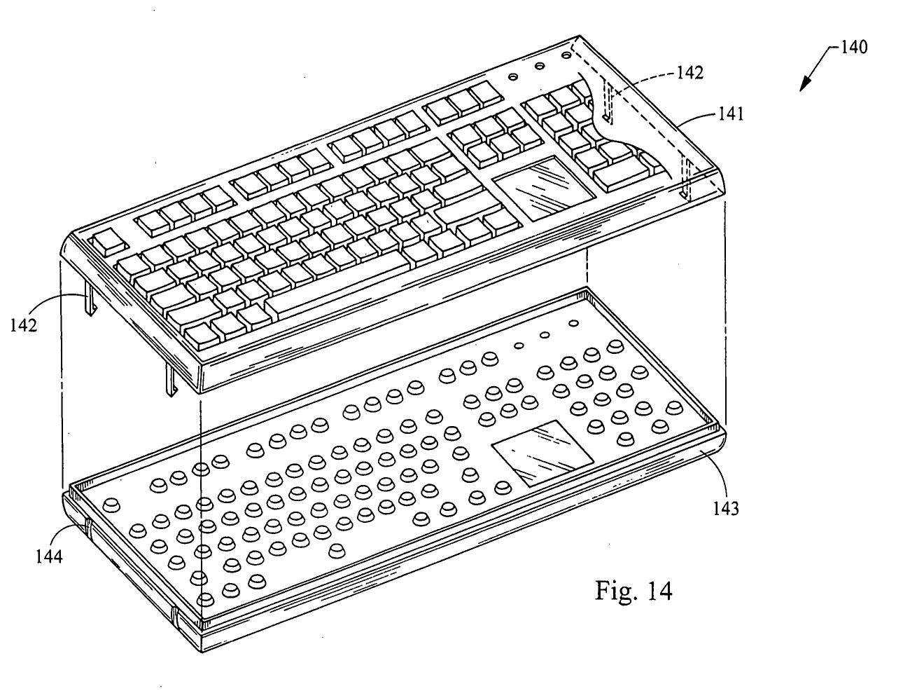

Alternatively, the two portions of the keyboard may be assembled without expensive latches by designing the keyboard for easy assembly and disassembly. FIG. 14 depicts a two-part cleanable keyboard 140 with an upper half 141 having posts 142 and a lower half 143 having matching receptacles 144. In this embodiment, the keyboard is assembled by simply placing posts 142 into receptacles 144. Posts 142 and receptacles 144 thus act as “quick” connections. The posts and receptacles preferably have a length suitable for assembly, and they even have snap-fit features for a more-reliable assembly. The posts may be molded with the keyboard frame or may be made separately and assembled to the frame, e.g., by snap fits, fasteners, or adhesive bonding.

The same effect may be achieved by using a raised portion on one half and a matching space on the other half, such as a tongue on one half and a groove on the other. It is not necessary that the raised portion and space extend around the entire perimeter, a short distance on the left and right sides, or on the front and back sides, is sufficient to join the halves and insure registration of the keycaps with detecting circuitry on the bottom portion. These assembling/joining portions are preferably outside of, and do not interfere with, the seal on the bottom portion.

The upper keyboard portion and the keys are most frequently handled by users when they enter data into a computer or other electronic device. Therefore, this is the portion that is removable by for cleaning. It is clearly preferable to clean the upper portion as a whole, without having to disassemble the frame from the keys. Accordingly, both the frame and keys are preferably made from a high performance thermoplastic or thermoset material, such as ABS, polycarbonate, Lexan, reinforced nylon, high-temperature polyesters, or phenolics. Obviously, the material must be solid and non-porous, especially on the surface, so that moisture is not retained. The upper keyboard with the keys should be capable of withstanding the temperature and humidity of a commercial dishwasher with temperatures of at least 160-170° F. (about 71 to 77° C.).

Ideally, the keyboard could withstand boiling water, and perhaps even temperatures above 212° F. (100° C.). For extreme use or when dealing with very dangerous biohazards, materials used for the keyboards and keys should be capable of withstanding autoclaving, at higher pressures and temperatures. Such materials may include polyetherimide (Ultem®), polyetheretherketone (PEEK®), or polyphenylsulfone (Radel® R). One example is autoclaving at 15 psig, at which point the temperature can reach 250° F. (121° C.). The keyboard, the keys, and the assembly should be designed for thermal stability in order to retain their dimensions and not warp. The upper portion should also be designed to retain as little moisture as possible and to allow moisture, such as from a dishwasher or an autoclave, to run off or drain quickly.

The keyboard, the keys, the frame for the keyboard, the lower housing, or the impermeable layer atop the lower or base portion of the keyboard may also be coated. Any one or more of these may have a tough, water and scuff resistant coating to insure long lasting service. Additionally, a coating that is resistant to germs and diseases may be desirable. Thus, a coating that is resistant to growth of bacteria (bacteriostatic) or cidal to bacterial (bactericidal) may be used, especially on the upper portion, the keys and the frame, although they may also be used for the lower housing or for the plastic or elastomeric seal used atop the lower portion. The coatings may alternately be resistant to fungi or viruses, or be cidal to fungi or viruses. Typically, the same material in a low concentration may be resistant to growth, while in a higher concentration it is cidal to the same organism.

Rather than limiting these materials to coatings, they may be incorporated into the plastic or rubber materials used for keys, frames, housings or elastomeric films. Thus, the entire part or component may be bactericidal, viricidal, or fungicidal, if used in a higher concentration, or may be bacteriostatic, viristatic, or fungistatic at lower concentrations. For example, an amount of about 0.1% to about 0.5% of antimicrobial compound by weight may be sufficient to impart resistance to growth of microorganisms, while a higher amount may be necessary to impart cidal qualities to the surface of a part of which the material is made or coated.

Many materials are known to have properties of resistance to such microorganisms. These materials are described in numerous places in open medical and other literature. A number of such materials are described and disclosed in U.S. Pat. No. 4,847,088, U.S. Pat. No. 6,663,824, and U.S. Pat. No. 6,776,824, all of which are hereby incorporated by reference in their entirety as though they were copied directly into this patent. For instance, quaternary ammonium compounds (frequently with organic or silicate side chains) are well-known for such properties, as is boric acid and many carboxylic acids, such as citric acid, benzoic acid, and maleic acid. Pyridinium and phosphonium salts may also be used. Besides organic compounds, many non-organic materials and compounds, are also known for their resistance to germs and organisms.

Metals, especially heavy metals, and ionic compounds and salts of these metals, are known to be useful as antimicrobials even in very low amounts or concentrations. These substances are said to have an oligodynamic effect, and they are considered oligodynamic. The metals include silver, gold, zinc, copper, cerium, gallium, platinum, palladium, rhodium, iridium, ruthenium, osmium, zinc, bismuth, and others. Other metals with lower atomic weights also have an inhibiting or cidal effect on microorganisms in very low concentrations. These metals include aluminum, calcium, sodium, lithium, magnesium, potassium, manganese, and lithium, among others. For present purposes all these metals are oligodynamic metals, and their compounds and ionic substances are oligodynamic substances. The metals, their compounds and ions, e.g., zinc oxide, silver acetate, silver nitrate, silver chloride, silver iodide and many others, may inhibit the growth of microorganisms, such as bacteria, viruses, or fungi, or they may have cidal effects on microorganisms, such as bacteria, viruses, or fungi, in higher concentrations. Because many of these compounds and salts are soluble, they may easily be placed into solution or a coating, which may then be used to coat the upper or lower portion of the keyboard, or both portions.

Other materials, such as sulfanilamide and cephalosporins, are well-known for their resistance properties, including chlorhexidine, ethanol, benzyl alcohol, lysostaphin, benzoic acid analog, lysine enzyme and metal salt, bacitracin, methicillin, cephalosporin, polymyxin, cefaclor, Cefadroxil, cefamandole nafate, cefazolin, cefime, cefinetazole, cefonioid, cefoperazone, ceforanide, cefotanme, cefotaxime, cefotetan, cefoxitin, cefpodoxime proxetil, ceftaxidime, ceftizomxime, ceftrizxone, cefriaxone moxalactam, cefuroxime, cephalexin, cephalosporin C, cephalosporin C sodium salt, cephalothin, cephalothin sodium salt, cephapirin, cephradine, cefuroximeaxetil, dihdratecephaloghin, moxalactam, or loracarbef mafate. Microban “Additive B,” 5-chloro-2-(2,4 dichloro-phenoxy)-phenol is another such material.

Keyboards made from materials incorporating these additives as a coating or as an integral part of a contact surface will have resistance or cidal properties in proportion to the concentration of additive. What is desired is an amount or a concentration sufficient to have the desired effect, resistance to growth of bacteria or other organisms, or cidal to an organism. Of course, the additive should remain on the contact surfaces and not itself contaminate objects or persons that contact the surfaces which have been coated or molded with these additives.

It is therefore intended that the foregoing detailed description be regarded as illustrative rather than limiting, and that it be understood that it is the following claims, including all equivalents, that are intended to define the spirit and scope of this invention.

What is claimed is:

1. A two-part cleanable keyboard, comprising:
an upper portion having a frame with at least two quick connections and a plurality of keycaps;
a lower portion with mating quick connections, the lower portion having a housing and a moisture resistant barrier, the lower portion also having a plurality of electrical circuits adapted to convert keystrokes into electrical signals, a control circuit connected to the electrical circuits, and an output circuit connected to the control circuit; and
a reactive mat further comprising a plurality of domes in registration with the plurality of keycaps, the reactive mat assembled to an underside of the upper portion or to an upper side of the lower portion.

2. The keyboard of claim 1 wherein the plurality of domes further comprises a plurality of activating members in registration with the plurality of electrical circuits.

3. The keyboard of claim 1 wherein the reactive mat is resilient and the domes are configured to yield a full-travel tactile feel.

4. The keyboard of claim 1 wherein the electrical circuit comprises two printed circuit layers.

5. The keyboard of claim 1 wherein the output circuit comprises an infrared LED output or an RF antenna.

6. The keyboard of claim 1 wherein the upper portion or the lower portion further comprises a coating or an additive of an antibacterial, antiviral, anti-fungal, or antimicrobial material.

7. The keyboard of claim 1 wherein the lower portion further comprises a plurality of switches between the reactive mat and the plurality of electrical circuits.

8. A cleanable, two-part keyboard comprising:
a removable keypad frame having a plurality of keycaps; and
a sealed base portion further comprising
a housing;
a plurality of electrical circuits within the housing;
a control circuit connected to the plurality of electrical circuits; and
a moisture-resistant barrier adhered to the housing; and
a reactive mat assembled to an underside of the removable keypad or to an upper side of the base portion;

9. The keyboard of claim 8, wherein the plurality of electrical circuits comprises at least two layers and optionally an insulator between the at least two layers.

10. The keyboard of claim 8, wherein the base portion further comprises drain paths for moisture.

11. The keyboard of claim 8, wherein the reactive mat comprises a plurality of raised features spaced for registration with the plurality of keycaps and the plurality of electrical circuits.

12. The keyboard of claim 8, wherein the reactive mat is made from silicone rubber and further comprises a plurality of domes spaced for registration with the plurality of keycaps and the plurality of electrical circuits.

13. The keyboard of claim 8, further comprising quick connectors for joining the keypad and the base portion.

14. The keyboard of claim 8, wherein the keypad further comprises a coating or an additive of an antibacterial, antimicrobial, or antiviral material.

15. A two-part cleanable keyboard, comprising:
a removable, cleanable frame with a plurality of keycaps; and
a sealed base, the base comprising a housing, a reactive layer with a plurality of features in registration with the plurality of keycaps, a plurality of electric circuits in registration with the reactive layer, a control circuit connected to the plurality of electrical circuits, and a sealing layer, wherein the frame and the base further comprise quick connectors, and the keycaps and reactive layer are configured for a user to receive a full-travel tactile feedback during use.

16. The keyboard of claim 15, further comprising a wireless transmitter connected to the control circuit.

17. The keyboard of claim 15, further comprising an output connector connected to the control circuit.

18. The keyboard of claim 15, further comprising a coating on at least one of the keycaps and the frame.

19. The keyboard of claim 15, further comprising a coating that is configured to inhibit the growth of or is cidal to bacteria, microbes or viruses.

20. The keyboard of claim 15, wherein the keyboard, the housing, or the sealing layer comprises an antibacterial, antiviral, or antimicrobial material.

21. The keyboard of claim 20, wherein the material is selected from the group consisting of oligodynamic metals, a quaternary ammonium compound, and an organosilane.
